(19) United States
(12) Patent Application Publication
(10) Pub. No.: US 2016/0304316 A1
(43) Pub. Date: Oct. 20, 2016

(54) HIGH SPEED ROPELESS ELEVATOR WITH DIFFERENT NUMBER OF HOISTWAYS UP AND DOWN IN A GROUP

(71) Applicant: OTIS ELEVATOR COMPANY, Farmington, CT (US)

(72) Inventors: Tadeusz Witczak, Lodz (PL); Daryl J. Marvin, Farmington, CT (US); Zbigniew Piech, Cheshire, CT (US)

(21) Appl. No.: 15/101,145

(22) PCT Filed: Dec. 5, 2013
(86) PCT No.: PCT/US2013/073311

§ 371 Date: Jun. 2, 2016

(51) Int. Cl. B66B 9/00; B66B 1/24

(52) U.S. Cl. CPC B66B 9/003; B66B 1/2466; B66B 1/2491; B66B 11/0407

(57) ABSTRACT

A ropeless elevator system (80) is disclosed. The ropeless elevator system (80) includes a plurality of hoistways (22, 26, 72) in which a plurality of elevator cars (24) circulate to a plurality of floors. Each hoistway (22, 26, 72) is assigned to a single direction of travel for the elevator cars (24). The single direction of travel is either upward or downward. A first quantity of upward hoistways (86) is unequal to a second quantity of downward hoistways (88), and a speed of each of the plurality of elevator cars (24) in the upward hoistways (86) is greater than a speed of each of the plurality of elevator cars in the downward hoistways (88).

### FIELD OF THE DISCLOSURE

The present disclosure relates generally to elevators and, more particularly, to self-propelled elevator systems.

### BACKGROUND OF THE DISCLOSURE

Self-propelled elevator systems, sometimes including and referred to as ropeless elevator systems, are useful in certain applications, such as, high rise buildings, where the mass of the ropes for a conventional roped elevator system is prohibitive and it is beneficial to have multiple elevator cars in a single shaft. In some self-propelled elevator systems, a first hoistway is designated for upward travel of the elevator cars, and a second hoistway is designated for downward travel of the elevator cars. In addition, transfer stations may be used to move the elevator cars horizontally between the first and second hoistways.

### SUMMARY OF THE DISCLOSURE

An exemplary embodiment of the present invention is directed to a ropeless elevator system. The exemplary ropeless elevator system may comprise a plurality of hoistways in which a plurality of elevator cars circulate to a plurality of floors, each hoistway assigned to a single direction of travel for the elevator cars, wherein the single direction of travel is either upward or downward. A first quantity of upward hoistways may be unequal to a second quantity of downward hoistways, and a speed of each of the plurality of elevator cars in the upward hoistways may be greater than a speed of each of the plurality of elevator cars in the downward hoistways.

According to another exemplary embodiment, a method for dispatching a plurality of elevator cars within a plurality of hoistways in an elevator system is disclosed. The elevator system may have a control system communicating with a control unit positioned in each of the elevator cars. The method may comprise assigning to each hoistway a single direction of travel for the elevator cars, wherein the single direction is either upward or downward. The method may further comprise moving the elevator cars at a higher speed within the upward hoistways than within the downward hoistways; changing the assignment for the direction of travel in at least one of the plurality of hoistways; and re-assigning to the at least one of the plurality of hoistways the changed assignment for the direction of travel.

According to another exemplary embodiment, a ropeless elevator system is disclosed. The ropeless elevator system may comprise a first hoistway in which a plurality of elevator cars travel upward; a second hoistway in which the plurality of elevator cars travel downward; a third hoistway in which the plurality of elevator cars travel upward, the first hoistway and the third hoistway positioned adjacent to the second hoistway; an upper transfer station positioned above the first hoistway, the second hoistway, and the third hoistway; and a lower transfer station positioned below the first hoistway, the second hoistway, and the third hoistway, the plurality of elevator cars moveable between the first hoistway, the second hoistway, and the third hoistway by way of the upper transfer station or the lower transfer station. A maximum allowable speed of each elevator car travelling within the first hoistway and the third hoistway may be greater than a maximum allowable speed of each elevator car travelling within the second hoistway.

Although various features are disclosed in relation to specific exemplary embodiments, it is understood that the various features may be combined with each other, or used alone, with any of the various exemplary embodiments without departing from the scope of the disclosure. For example, the first quantity of upward hoistways may be greater than the second quantity of downward hoistways. The second quantity of downward hoistways may be greater than the first quantity of upward hoistways. The single direction of travel for the elevator cars may be dynamically assignable. The single direction of travel for the elevator cars in each hoistway may be assigned according to a first assignment and later re-assigned according to a subsequent assignment.

In other examples, each elevator car may have a control unit in communication with a control system, the control system programmed to dynamically assign each hoistway to the single direction of travel and to communicate to the control units the direction of travel of each hoistway. The ropeless elevator system may further comprise a transfer station positioned across the plurality of hoistways, each elevator car moveable from one hoistway to an adjacent hoistway by way of the transfer station. The transfer station may include at least two vertical levels to support simultaneous transfer of the elevator cars from different hoistways to a same hoistway. The plurality of elevator cars may not have an air pressurization system.

These and other aspects and features will become more readily apparent upon reading the following detailed description when taken in conjunction with the accompanying drawings.

### BRIEF DESCRIPTION OF THE DRAWINGS

FIG. 1 depicts an elevator system according to an exemplary embodiment;

FIG. 2 is a top down view of an elevator car in a hoistway in an exemplary embodiment;

FIG. 3 is a top down view of a moving portion of a propulsion system in an exemplary embodiment;

FIG. 4 is a top down view of a stationary portion and a moving portion of a propulsion system in an exemplary embodiment;

FIG. 5 is a perspective view of an elevator car and a propulsion system in an exemplary embodiment;

FIG. 6 depicts another elevator system in an exemplary embodiment;

FIG. 7 depicts another elevator system in an exemplary embodiment;

FIG. 8 is a schematic representation of an assignment of travel direction in a plurality of hoistways from a top down view in an exemplary embodiment;

FIG. 9 is a schematic representation of another assignment of travel direction in a plurality of hoistways from a top down view in an exemplary embodiment;

FIG. 10 is a schematic representation of another assignment of travel direction in a plurality of hoistways from a top down view in an exemplary embodiment;

FIG. 11 is a flowchart illustrating an exemplary process for dispatching a plurality of elevator cars within a plurality of hoistways in an elevator system in an exemplary embodiment; and

FIG. 12 depicts a top down view of another elevator system in an exemplary embodiment.

While the present disclosure is susceptible to various modifications and alternative constructions, certain illustrative embodiments thereof will be shown and described below in detail. The invention is not limited to the specific embodiments disclosed, but instead includes all modifications, alternative constructions, and equivalents thereof.

### DETAILED DESCRIPTION

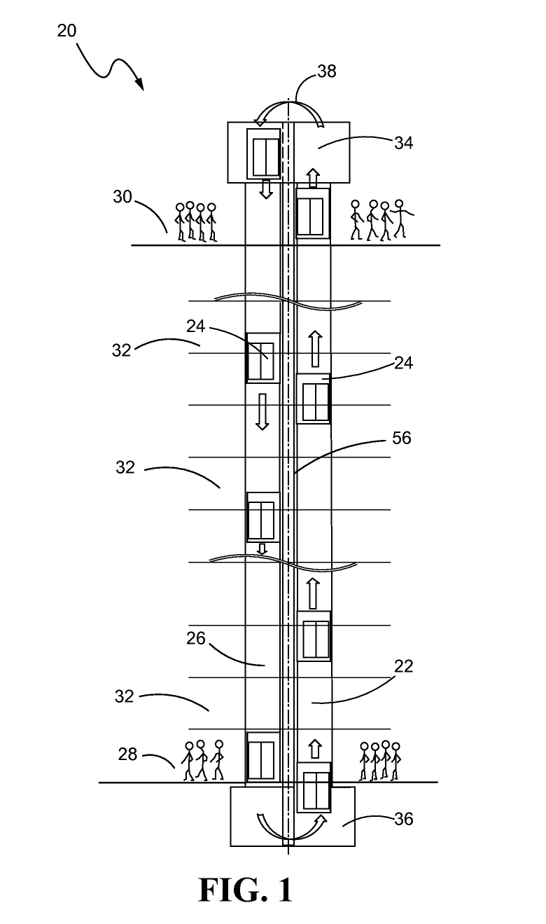

FIG. 1 depicts an elevator system 20 in an exemplary embodiment. This elevator system 20 is shown for illustrative purposes to assist in disclosing various embodiments of the invention. As is understood by a person skilled in the art, FIG. 1 does not depict all of the components of an exemplary elevator system, nor are the depicted features necessarily included in all elevator systems.

As shown in FIG. 1, the elevator system 20 includes a first hoistway 22 in which a plurality of elevator cars 24 travel upward and a second hoistway 26 in which the plurality of elevator cars 24 travel downward. Elevator system 20 transports elevator cars 24 from a first floor 28 to a top floor 30 in first hoistway 22 and transports elevator cars 24 from the top floor 30 to the first floor 28 in second hoistway 26. Although not shown, elevator cars 24 may also stop at intermediate floors 32 to allow ingress to and egress from an elevator car intermediate the first floor 28 and top floor 30.

Positioned across the first and second hoistways 22, 26 above the top floor 30 is an upper transfer station 34. Upper transfer station 34 imparts horizontal motion to elevator cars 24 to move the elevator cars 24 from the first hoistway 22 to the second hoistway 26. It is understood that upper transfer station 34 may be located at the top floor 30, rather than above the top floor 30. Positioned across the first and second hoistways 22, 26 below the first floor 28 is a lower transfer station 36. Lower transfer station 36 imparts horizontal motion to elevator cars 24 to move the elevator cars 24 from the second hoistway 26 to the first hoistway 22. It is to be understood that lower transfer station 36 may be located at the first floor 28, rather than below the first floor 28.

Together, the first hoistway 22, the upper transfer station 34, the second hoistway 26, and the lower transfer station 36 comprise a loop 38 in which the plurality of cars 24 circulate to the plurality of floors 28, 30, 32 and stop to allow the ingress and egress of passengers to the plurality of floors 28, 30, 32.

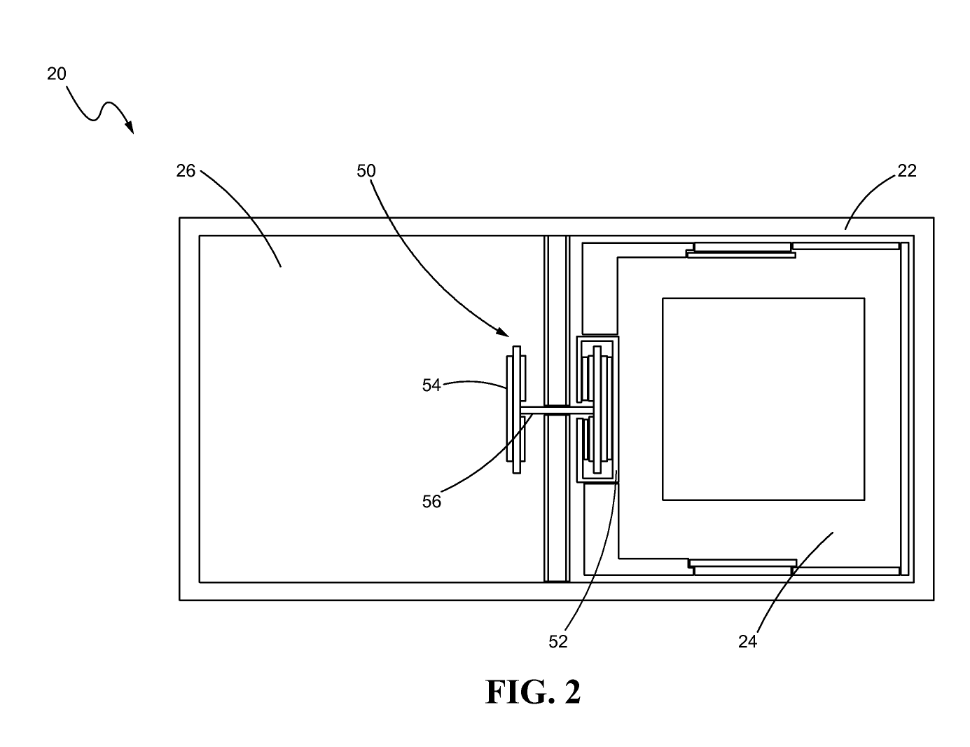

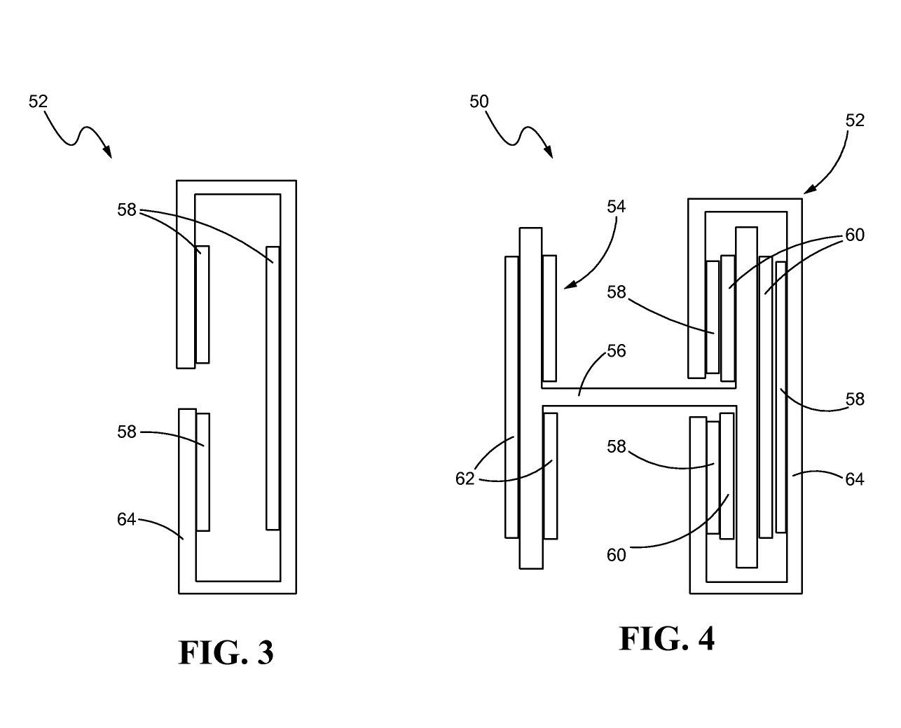

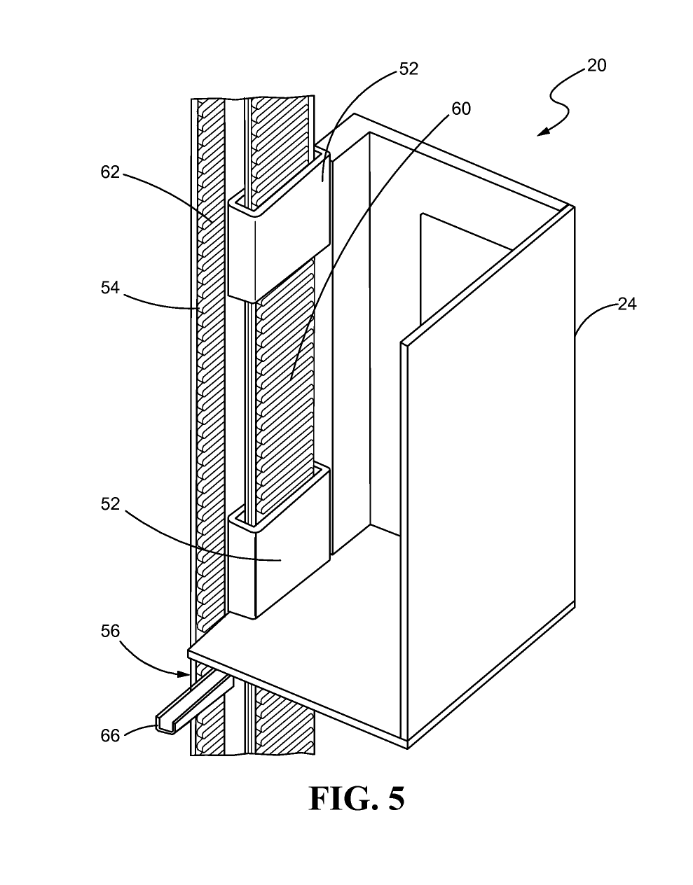

Turning now to FIGS. 2-5, with continued reference to FIG. 1, elevator system 20 includes a propulsion system 50 disposed on the elevator cars 24, in the hoistways 22, 26, and in the transfer stations 34, 36, 42. The propulsion system 50 imparts vertical motion to elevator cars 24 to propel the elevator cars from one level to the next within the hoistways 22, 26 and into and out of the transfer stations 34, 36, 42. Different types of motors can be used for the propulsion system 50, such as, but not limited to, a linear permanent magnet motor, a flux switching motor, an induction motor, a friction motor, or the like. The propulsion system 50 may comprise a moving part 52 mounted on each elevator car 24 and a stationary part 54 mounted to a structural member 56 positioned within the hoistways 22, 26 and transfer stations 34, 36, 42. The interaction of the moving part 52 and the stationary part 54 generates a thrust force to move the elevator cars 24 in a vertical direction within the hoistways 22, 26 and transfer stations 34, 36, 42.

In an example, the moving part 52 includes permanent magnets 58, and the stationary part 54 includes windings 60, 62 mounted on structural member 56. Permanent magnets 58 may be attached to a support element 64 of the moving part 52, with the support element 64 coupled to the elevator car 24. Structural member 56 may be made of a ferromagnetic material and coupled to a wall of the first and/or second hoistways 22, 26 by support brackets 66. Windings 60, 62 may be formed about structural member 56. Windings 60 provide the stationary part of the propulsion system within the first hoistway 22, and windings 62 provide the stationary part of the propulsion system within the second hoistway 26. A support element 64 of the moving part 52 may be positioned about windings 60, 62 such that the windings 60, 62 and permanent magnets 58 are adjacent.

Windings 60 in the first hoistway 22 are energized by a power source (not shown) to propel one or more elevator cars 24 upward in the first hoistway 22 and transfer stations 34, 36, 42. When a voltage is applied to windings 60, the interaction between the windings 60 and permanent magnets 58 impart motion to the elevator car 24. Windings 62 in the second hoistway 26 operate as a regenerative brake to control descent of the elevator car 24 in the second hoistway 26 and transfer stations 34, 36, 42. Windings 62 also provide a current back to the drive unit, for example, to recharge an electrical system.

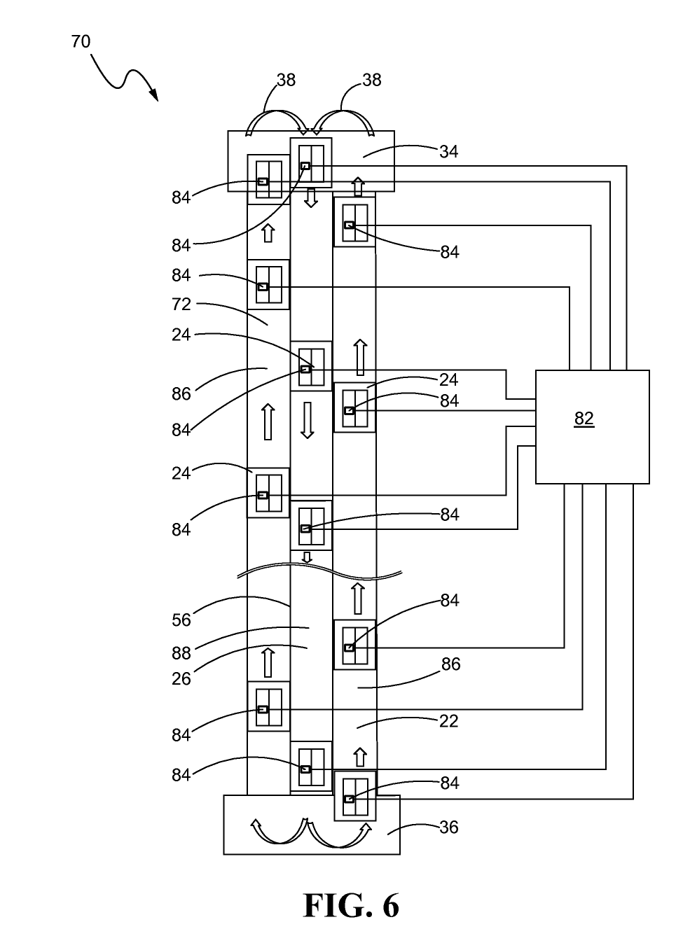

Referring now to FIG. 6, with continued reference to FIGS. 1-5, therein is illustrated an elevator system 70 in another exemplary embodiment. Elements of FIG. 6 corresponding to elements in FIG. 1 are labeled with the same reference numerals where practicable. As shown schematically in FIG. 6, elevator system 70 includes a plurality of hoistways 22, 26, 72 in which the plurality of elevator cars 24 circulate to the plurality of floors. Although only three hoistways 22, 26, 72 are shown, it is to be understood that more or less than three hoistways may be used.

Elevator system 70 further includes a control system 82 in communication with a control unit 84 mounted on each of the elevator cars 24. The control system 82 and control units 84 may comprise a processor (e.g., “computer processor”) or processor-based device that may include or be associated with a non-transitory computer readable storage medium having stored thereon computer-executable instructions. It is to be understood that the control system 82 and control units 84 may include other hardware, software, firmware, or combinations thereof.

The control system 82 and control units 84 are configured to control dispatching of the elevator cars 24 to the plurality of floors. Algorithms or sets of instructions for dispatching the elevator cars 24 around the loop 38 and assigning directions of travel for the elevator cars 24 within the hoistways 22, 26, 72 may be programmed into a memory of the control system 82 and/or control units 84. The control system 82 may be located in a building where the elevator system 70 is located, a remote location away from the elevator system 70, or a cloud-based system. The control system 82 may communicate with the control units 84 in each of the elevator cars through wired or wireless connections, such as, without limitation, cables, the Global System for Mobile Communications (GSM), Wi-Fi, or the like.

In an exemplary embodiment, each of the hoistways 22, 26, 72 is assigned to a single direction of travel for the elevator cars 24. The single direction of travel within each hoistway 22, 26, 72 is either upward or downward. The control system 82 may be programmed to assign to each hoistway 22, 26, 72 the single direction of travel and to communicate to the control units 84 of the elevator cars 24 the direction of travel in each hoistway 22, 26, 72. When the control system 82 dispatches the elevator cars 24 within the hoistways 22, 26, 72 to the plurality of floors, the elevator cars 24 only travel in the direction to which each hoistway 22, 26, 72 is assigned.

In the plurality of hoistways 22, 26, 72, there is assigned a first quantity of upward hoistways 86 and a second quantity of downward hoistways 88. The first quantity of upward hoistways 86 may be unequal to the second quantity of downward hoistways 88, although the first quantity of upward hoistways may also be equal to the second quantity of downward hoistways. The first quantity of upward hoistways 86 may be greater than the second quantity of downward hoistways 88. Alternatively, the second quantity of downward hoistways may be greater than the first quantity of upward hoistways. The elevator cars may travel faster in the upward hoistways than in the downward hoistways.

For example, as shown in FIG. 6, the first hoistway 22 and the third hoistway 72 are assigned as upward hoistways 86, and the second hoistway 26 is assigned as a downward hoistway 88. Elevator cars 24 travel upward in the first and third hoistways 22, 72, transfer to the second hoistway 26 in the upper transfer station 34, travel downward in the second hoistway 26, and transfer to the first and third hoistways in the lower transfer station 36, thereby comprising two loops 38 for travel to the plurality of floors.

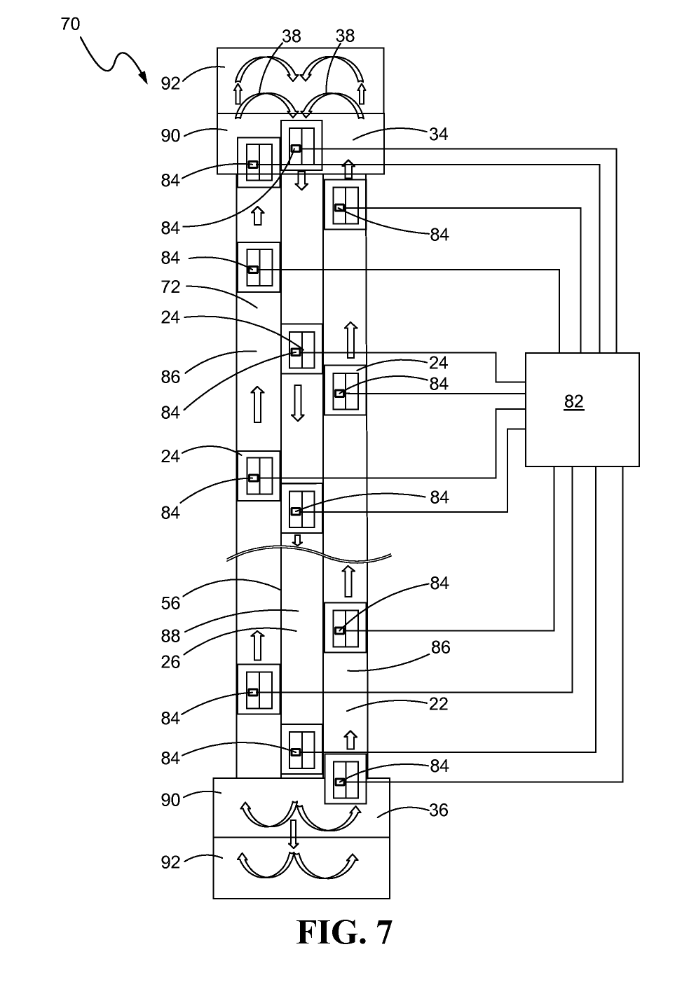

Each of the upper and lower transfer stations 34, 36 may comprise only one level, with the control system 82 programmed to synchronize transfer of the elevator cars 24 into the second hoistway 26. To avoid the elevator cars 24 entering the second hoistway 26 at the same time, the control system 82 may transfer elevator cars 24 from the first hoistway 22 to the second hoistway 26 at a different time than the transfer of elevator cars 24 from the third hoistway 72 to the second hoistway 22. Alternatively, as shown best in FIG. 7, the upper and lower transfer stations 34, 36 may each comprise two vertical levels 90, 92 to support simultaneous transfer of elevator cars 24 from both first and third hoistways 22, 72 into the second hoistway 26. With two levels 90, 92, one elevator car 24 can be transferred from the first hoistway 22 into the second hoistway 26 at the same time another elevator car 24 is transferred from the third hoistway 72 into the second hoistway 26. It is to be understood that more than two levels in the transfer station may be used.

Each of the elevator cars may travel at a higher speed in the upward hoistways 86 than in the downward hoistways 88. With the speed of each elevator car greater in the upward hoistways 86 than in the downward hoistways 88, physiological responses in passengers to rapid pressure changes are alleviated when travelling within the hoistways. As such, an air pressurization system having an output connected to an interior compartment (sized to carry people or cargo) of each elevator car 24 is not needed.

The higher speed of travel by the elevator cars 24 in the upward hoistways 86 than in the downward hoistway 88 may be supported by having a greater number of upward hoistways 86 than downward hoistways 88. A higher speed of travel may require longer safety buffer distances than a slower speed of travel. It is beneficial to have more upward hoistways 86 than downward hoistways 88 to provide greater distances between upward traveling elevator cars 24. With a smaller quantity of downward hoistways 88 than upward hoistways 86, more elevator cars 24 can travel within a single downward hoistway 88 (compared to a single upward hoistway 86) due to the slower speed of travel in the downward hoistways 88.

The assignment of upward hoistways 86 and downward hoistways 88 may be static or dynamic. In a static assignment, the direction each hoistway 22, 26, 42 is assigned to does not change, unless manually modified by authorized personnel. The static assignment may be preprogrammed into a memory of the control system and/or control units 84 of the elevator cars 24. The control system 82 then dispatches the elevator cars 24 within the hoistways 22, 26, 42 to travel only in the direction the hoistway is statically assigned. According to a further embodiment in which the assignments are statically assigned, the stationary parts 54 of linear motors in the downward hoistway(s) differ from those in the upward hoistway(s). That is, according to another embodiment, the downward hoistways may utilize stationary parts 54 that are limited in the amount of force they produce compared to the stationary parts 54 in the upward hoistways as a result of the slower speeds allowable.

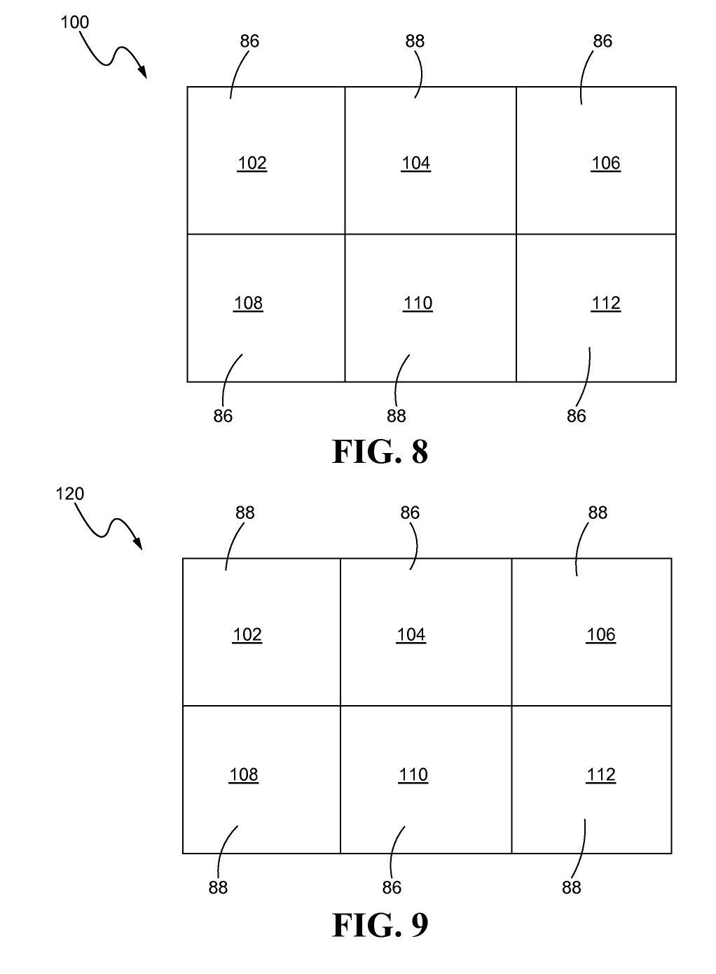

In a dynamic assignment, the direction each hoistway 22, 26, 42 is assigned to does change depending on the needs of the elevator system. Each hoistway may be assigned according to a first assignment and later re-assigned according to subsequent assignments. For example, as shown in FIG. 8, hoistways 102-112 are designated according to a first assignment 100. The first assignment 100 includes four upward hoistways 86 and two downward hoistways 88, each upward hoistway 88 positioned adjacent to a downward hoistway 88. Then at a later time, as shown in FIG. 9, hoistways 102-112 may be designated according to a second assignment 120, which includes two upward hoistways 86 and two downward hoistways 88, each downward hoistway 88 positioned adjacent to an upward hoistway 86.

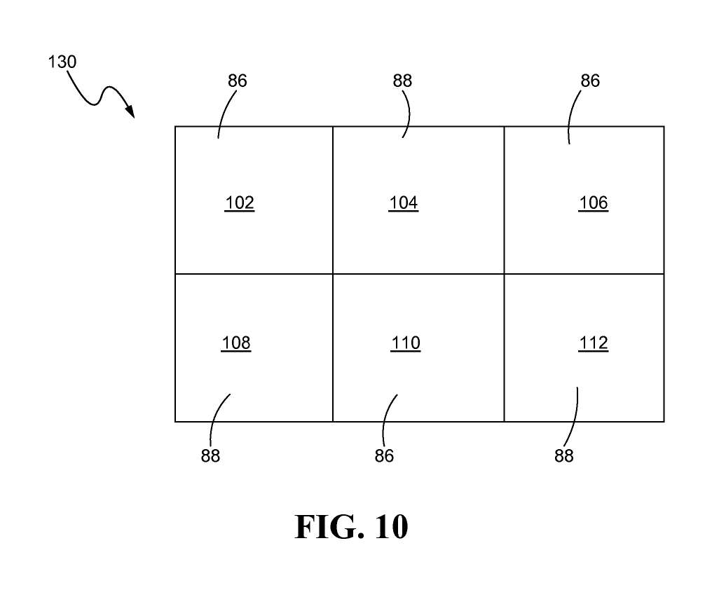

At a subsequent time, as shown in FIG. 10, hoistways 102-112 may be designated according to a third assignment 130, which includes three upward hoistways 86 and three downward hoistways 88, each upward hoistway 86 positioned adjacent to a downward hoistway 88. The control system 82 may be programmed to dynamically assign each hoistway 102-112 to a single direction, communicating to each of the control units 84 in the elevator cars 24 the assignment and later re-assignment(s) of the direction of travel in each hoistway, and dispatching the elevator cars 24 within the hoistways according to the assignment and later re-assignment(s).

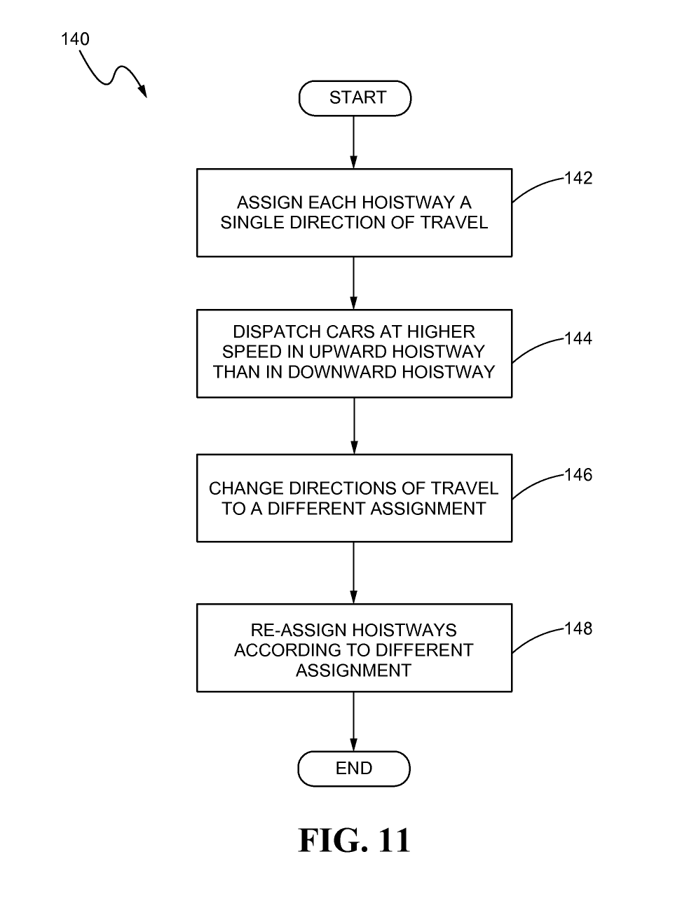

The flowchart of FIG. 11 illustrates an exemplary process 140 for dispatching the plurality of elevator cars 24 within the plurality of hoistways 22, 26, 30 in the elevator system 70. At block 142, the control system 82 assigns to each hoistway a single direction of travel for the elevator cars 24, wherein the single direction is either upward or downward. At block 144, the control system 82 dispatches the elevator cars 24 at a higher speed within the upward hoistways 86 than within the downward hoistways 88. The control system 82 changes the assignment for the directions of travel in the plurality of hoistways 22, 26, 30 to a different assignment for the directions of travel at block 146. At block 148, the control system 82 re-assigns to the plurality of hoistways 22, 26, 30 the different assignment for the directions of travel.

Dynamic assignment of the direction of travel within each of the hoistways can provide efficient dispatching to accommodate needs of a building. For example, a usage pattern of the elevator system during different times of the day, an approximate number of passengers using the elevator system at each of the floors, and/or an estimated usage pattern for future events (e.g., conferences), can be determined. Based off of this information, the hoistways can be assigned to a specific plan for upward and downward travel, and also later re-assigned to a different plan for upward and downward travel, in order to accommodate the usage pattern of the elevator system and fluctuating ingress and egress of passengers to and from specific floors.

For example, in an office building, more upward hoistways than downward hoistways may be assigned in the morning, and near the end of the work day the hoistway direction assignment may change such that there are more downward hoistways than upward hoistways. In another example, if there is a scheduled conference, the direction of travel within the hoistways may be assigned and later re-assigned to accommodate a starting time, break time, and ending time. Alternatively, if the control system receives a significant number of calls to go in the upward direction compared to the number of calls to go in the downward direction, the control system can change the assignment of one of the downward hoistways to an upward hoistway. The control system can change the assignment dynamically to adapt to the changing demands of the passengers, thereby increasing dispatching efficiency. This can be accomplished within a set number of hoistways, thereby not only reducing waiting time for the elevator cars and travel time, but also reducing a hoistway surface footprint in the building.

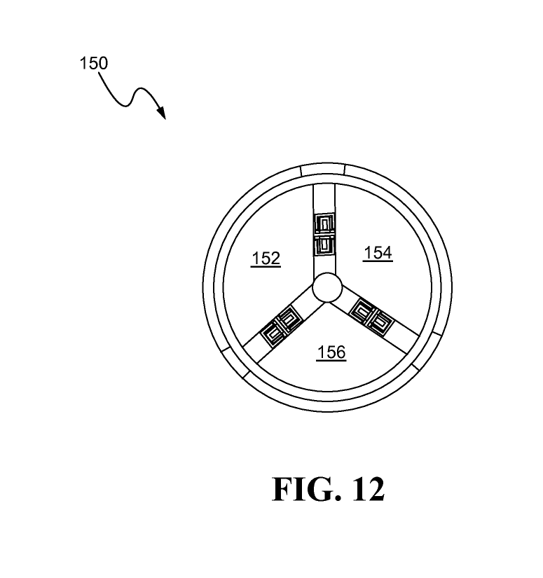

It is to be understood that although rectangular-shaped hoistways are shown and described above, non-traditional elevator configurations and shapes may also be used. For example, as shown best in FIG. 12, elevator system 150 may comprise a circular elevator system having hoistways 152, 154, 156 which are assigned to either an upward or downward direction of travel for the elevator cars. In addition, dynamic assignment of the travel direction in the hoistways 152, 154, 156 of the circular elevator system 150 can increase dispatching efficiency and reduce a hoistway surface footprint.

By using the elevator systems and methods disclosed herein, simplified traffic management and dispatching efficiency is achieved. By assigning a single direction to each hoistway for travel of the elevator cars and dynamically re-assigning the direction of travel in the hoistways, travel time within the elevator system is reduced, as well as a hoistway surface footprint of the elevator system in a building. Furthermore, assigning a greater quantity of upward hoistways than downward hoistways can eliminate the need for air pressurization systems within the interior compartments of the elevator cars.

While the foregoing detailed description has been given and provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims appended hereto.

While some features are described in conjunction with certain specific embodiments of the invention, these features are not limited to use with only the embodiment with which they are described, but instead may be used together with or separate from, other features disclosed in conjunction with alternate embodiments of the invention.

What is claimed is:

1. A ropeless elevator system (70) comprising:
a plurality of hoistways (22, 26, 72) in which a plurality of elevator cars (24) circulate to a plurality of floors, each hoistway (22, 26, 72) assigned to a single direction of travel for the elevator cars (24), wherein the single direction of travel is either upward or downward, wherein a first quantity of upward hoistways (86) is unequal to a second quantity of downward hoistways (88), and wherein a speed of each of the plurality of elevator cars (24) in the upward hoistways (86) is greater than a speed of each of the plurality of elevator cars (24)in the downward hoistways (88).

2. The ropeless elevator system of claim 1, wherein the first quantity of upward hoistways (86) is greater than the second quantity of downward hoistways (88).

3. The ropeless elevator system of claim 1, wherein the second quantity of downward hoistways (88) is greater than the first quantity of upward hoistways (86).

4. The ropeless elevator system of claim 1, wherein the single direction of travel for the elevator cars (24) is dynamically assignable.

5. The ropeless elevator system of claim 4, wherein the single direction of travel for the elevator cars (24) in each hoistway is assigned according to a first assignment and later re-assigned according to a subsequent assignment.

6. The ropeless elevator system of claim 1, wherein each elevator car (24) has a control unit (84) in communication with a control system (82), the control system (82) programmed to dynamically assign each hoistway to the single direction of travel and to communicate to the control units (84) the direction of travel of each hoistway.

7. The ropeless elevator system of claim 1, further comprising a transfer station (34, 36) positioned across the plurality of hoistways (22, 26, 72), each elevator car (24) moveable from one hoistway to an adjacent hoistway by way of the transfer station (34, 36).

8. The ropeless elevator system of claim 8, wherein the transfer station (34, 36) includes at least two vertical levels (90, 92) to support simultaneous transfer of the elevator cars from different hoistways (22, 72) to a same hoistway (26).

9. The ropeless elevator system of claim 1, wherein the plurality of elevator cars (24) do not have an air pressurization system.

10. A method (140) for dispatching a plurality of elevator cars (24) within a plurality of hoistways (22, 26, 72) in an elevator system (70), the elevator system (70) having a control system (82) communicating with a control unit (84) positioned in each of the elevator cars (24), the method (140) comprising:
assigning to each hoistway (22, 26, 72) a single direction of travel for the elevator cars (24), wherein the single direction is either upward or downward;
moving the elevator cars (24) at a higher speed within the upward hoistways (86) than within the downward hoistways (88);
changing the assignment for the direction of travel in at least one of the plurality of hoistways (22, 26, 72); and
re-assigning to the at least one of the plurality of hoistways (22, 26, 72) the changed assignment for the direction of travel.

11. The method of claim 10, wherein assigning to each hoistway a single direction of travel for the elevator cars (24) includes assigning more hoistways in the upward direction of travel than in the downward direction of travel.

12. The method of claim 10, wherein assigning to each hoistway a single direction of travel for the elevator cars (24) includes assigning each hoistway in the upward direction of travel adjacent to a hoistway in the downward direction of travel.

13. The method of claim 10, wherein changing the assignment for the directions of travel within the plurality of hoistways includes analyzing a usage pattern of the elevator system (70).

14. The method of claim 10, further comprising the control system (82) communicating to the control unit (84) in each elevator car (24) the assignment for the directions of travel of each hoistway.

15. The method of claim 14, further comprising the control system (82) communicating to the control unit (84) in each elevator car (24) the different assignment for the directions of travel when the plurality of hoistways are re-assigned.

16. A ropeless elevator system (70) comprising:
a first hoistway (22) in which a plurality of elevator cars (24) travel upward;
a second hoistway (26) in which the plurality of elevator cars (24) travel downward;
a third hoistway (72) in which the plurality of elevator cars (24) travel upward, the first hoistway (22) and the third hoistway (72) positioned adjacent to the second hoistway (26);
an upper transfer station (34) positioned above the first hoistway (22), the second hoistway (26), and the third hoistway (72); and
a lower transfer station (36) positioned below the first hoistway (22), the second hoistway (26), and the third hoistway (72), the plurality of elevator cars (24) moveable between the first hoistway (22), the second hoistway (26), and the third hoistway (72) by way of the upper transfer station (34) or the lower transfer station (36),
wherein a maximum allowable speed of each elevator car (24) travelling within the first hoistway (22) and the third hoistway (72) is greater than a maximum allowable speed of each elevator car (24) travelling within the second hoistway (26).

17. The ropeless elevator system of claim 16, wherein the upper transfer station (34) and the lower transfer station (36) each include two levels (90, 92) to support simultaneous transfer of the elevator cars (24) from the first and third hoistways (22, 72) to the second hoistway (26).

18. The ropeless elevator system of claim 16, further comprising a control unit (84) mounted in each elevator car (24), the control unit (84) in communication with a control system (82) programmed to dispatch the plurality of elevator cars (24) within the first, second, and third hoistways (22, 26, 72).

19. The ropeless elevator system of claim 18, wherein the upper transfer station (34) and the lower transfer station (36) each include only one level, and wherein the control system (82) is further programmed to transfer the elevator cars (24) from the first hoistway (22) to the second hoistway (26) at a different time than the elevator cars transfer from the third hoistway (72) to the second hoistway (26).

20. The ropeless elevator system of claim 18, wherein the control system (82) is further programmed to change a direction of travel of the elevator cars (24) within the first, second, and third hoistways (22, 26, 72).
